(19) United States
(12) Patent Application Publication
(10) Pub. No.: US 2003/0204675 A1
(43) Pub. Date: Oct. 30, 2003

(54) Method and system to retrieve information from a storage device

(76) Inventors: Lance W. Dover, Fair Oaks, CA (US); Weiqiang Ma, Tempe, AZ (US); Brian R. Mears, Tempe, AZ (US); Sean S. Eilert, Penryn, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/136,018

(22) Filed: Apr. 29, 2002

(51) Int. Cl. G06F 12/00

(52) U.S. Cl. 711/137; 711/103

(57) ABSTRACT

Briefly, in accordance with an embodiment of the invention, a method to retrieve information from a flash memory is provided, wherein the method includes enabling prefetching in the flash memory and identifying nonrequested information in the flash memory if prefetching is enabled.

### BACKGROUND

Various kinds of memory devices may be used in computing systems to store information. Determining the appropriate methods and apparatuses to retrieve information from a memory device may be problematic. Since a computer system may make multiple accesses to a memory device during operation, the type of memory device and the algorithms for retrieving information from these memory devices may affect system performance.

Thus, there is a continuing need for alternate ways to retrieve information from memory in computing systems.

### BRIEF DESCRIPTION OF THE DRAWINGS

The subject matter regarded as the invention is particularly pointed out and distinctly claimed in the concluding portion of the specification. The claimed subject matter, however, both as to organization and method of operation, together with objects, features, and advantages thereof, may best be understood by reference to the following detailed description when read with the accompanying drawings in which:

FIG. 1 is a block diagram illustrating a computing system in accordance with an embodiment of the claimed subject matter; and

FIG. 2 is a flow chart illustrating a method to store retrieve information in accordance with an embodiment of the claimed subject matter.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION

In the following detailed description, numerous specific details are set forth in order to provide a thorough understanding of the claimed subject matter. However, it will be understood by those skilled in the art that the claimed subject matter may be practiced without these specific details. In other instances, well-known methods, procedures, components and circuits have not been described in detail so as not to obscure the claimed subject matter.

Embodiments of the claimed subject matter may include an apparatus for performing the operations herein. This apparatus may be specially constructed for the desired purposes, or it may comprise a general purpose computing device selectively activated or reconfigured by a program stored in the device. Such a program may be stored on a storage medium, such as, but is not limited to, any type of disk including floppy disks, optical disks, CD-ROMS, magnetic-optical disks, electromechanical disks, read-only memories (ROMs), random access memories (RAMs), electrically programmable read-only memories (EPROMs), electrically erasable and programmable read only memories (EEPROMs), flash memory, magnetic or optical cards, or any other type of media suitable for storing electronic instructions and data.

Embodiments of the claimed subject matter are not described with reference to any particular programming language. It will be appreciated that a variety of programming languages may be used to implement the teachings of the claimed subject matter as described herein. For example, high-level procedural, object-oriented, assembly, or machine programming languages may be used to implement the claimed subject matter.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

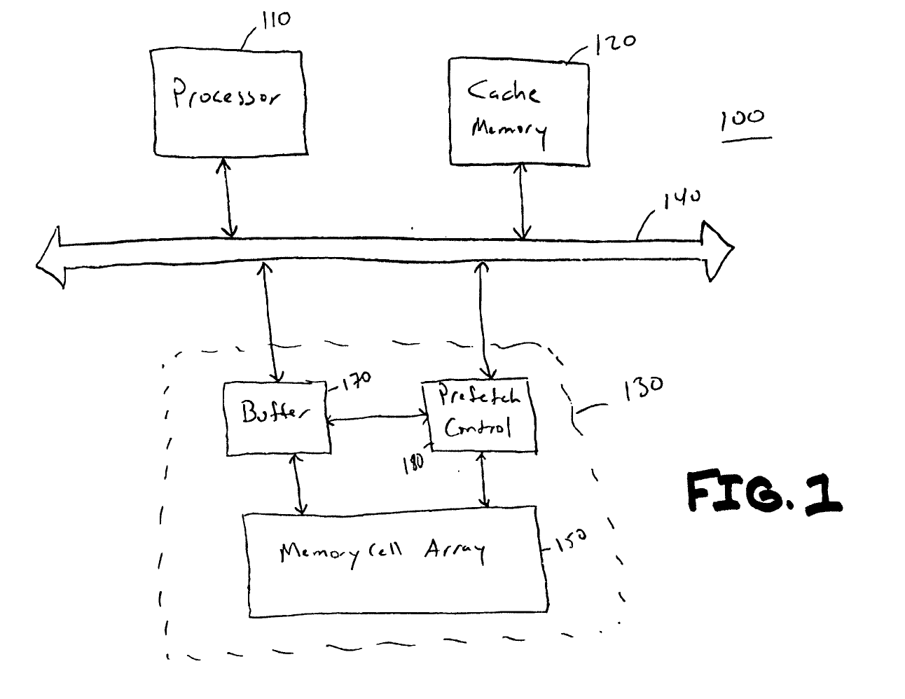

Turning to FIG. 1, an embodiment of a computing system 100 is illustrated. Computing system 100 may be used in a variety of applications such as, for example, a personal digital assistant (PDA), a two-way pager, a cellular phone, a portable computer, a desktop computer, a workstation, or a server. Although it should be pointed out that the scope and application of the claimed subject matter is in no way limited to these examples.

In this embodiment, computing system 100 may comprise a processor 110, a cache memory 120, and a flash memory 130 coupled to each other via a bus 140. Bus 140 may be a data path comprising, for example, a collection of data lines to transmit data from one part of computing system 100 to another.

Although the scope of the claimed subject matter is not limited in this respect, processor 110 may comprise, for example, one or more microprocessors, digital signal processors, microcontrollers, or the like. Processor 110 may execute a software process such as, for example, a software program or an operating system, wherein the software process may use digital information such as, for example, data and/or instructions.

Cache memory 120 and flash memory 130 may be referred to as storage devices and may be adapted to store information, such as, for example, instructions or data used by an operating system or a software program that may be executed by processor 110. Processor 110 may control cache memory 120 and flash memory 130. For example, processor 110 may control the transfer of information within computing system 100, e.g., between processor 110, cache memory 120, and flash memory 130. Processor 110 may be integrated (“on-chip”) with cache memory 120 and flash memory 130. In alternate embodiments, processor 110 may be a discrete component or dedicated chip, wherein processor 110 is external (“off-chip”) to cache memory 120 and flash memory 130. Similarly, cache memory 120 and flash memory 130 may be discrete components external to each other and processor 110. In other embodiments, processor 110 may incorporate a memory controller (not shown) to control the transfer of information within computing system 100. In alternate embodiments, portions of the functionality of a memory controller (not shown) may be implemented in processor 110 as, for example, a software application, module, or routine.

Cache memory 120 and flash memory 130 may have different physical properties such as, for example, different access times, storage capacity, power consumption, and volatile properties.

Access time may refer to the amount of time it takes to store information to, or read information from a memory device. As an example, cache memory 120 may be a relatively faster memory device compared to flash memory 130, i.e., the access time of cache memory 120 may be less than the access times of flash memory 130, although the scope of the claimed subject matter is not limited in this respect. In one embodiment, cache memory 120 may have an access time of less than 20 nanoseconds, e.g., approximately 10 nanoseconds. Flash memory 130 may have a relatively slower access time compared to cache memory 120, of at least 20 nanoseconds, e.g., approximately 50 nanoseconds. In alternate embodiments, although the scope of the claimed subject matter is not limited in this respect, cache memory 120 may have an access time of less than 10 nanoseconds, e.g., approximately one nanosecond. Flash memory 130 may have a relatively slower access time compared to cache memory 120 of at least 10 nanoseconds, e.g., approximately 20 nanoseconds.

Although the scope of the claimed subject matter is not limited in this respect, cache memory 120 may be a relatively smaller memory device compared to flash memory 130, e.g., the storage capability of cache memory 120 may be less than the storage capability of flash memory 130. For example, cache memory 120 may have a storage capacity of less than 32 megabits, e.g., approximately 16 megabits. Flash memory 130 may have a relatively larger storage capacity compared to cache memory 120, of at least 32 megabits, e.g., approximately 256 megabits.

As illustrated in some embodiments above, cache memory 120 may be a relatively smaller and faster type of memory device compared to flash memory 130. Cache memory 120 may cache frequently accessed information from flash memory 130 during operation of computing system 100, although the scope of the claimed subject matter is not limited in this respect. As frequently accessed information is requested from flash memory 130, it may be available in cache memory 120, thereby avoiding a relatively longer search and fetch in flash memory 130. Therefore, overall system performance may be improved by caching information in cache memory 120.

In some embodiments, cache memory 120 may be a volatile memory such as, for example, a static random access memory (SRAM) or a dynamic random access memory (DRAM), although the scope of the claimed subject matter is not limited in this respect. In alternate embodiments, cache memory 120 may be a nonvolatile memory. Cache memory 120 may also be a volatile memory with a battery backup, as the battery may prevent the memory from losing its contents when the main power source is off.

In this embodiment, flash memory 130 is an electrically programmable and electrically erasable nonvolatile storage device and may be a NAND or NOR type flash memory. Flash memory 130 may be capable of storing multiple bits per cell. Flash memory 130 may include a memory cell array 150 that may include a plurality of memory cells (not shown). Each memory cell may include a floating gate to store a charge (e.g., electrons or holes). The state of the memory may be determined by the absence or presence of electrons or holes on the floating gate.

Flash memory 130 may also include a buffer 170 and a prefetch control 180 coupled to each other, memory cell array 150, and bus 140. Buffer 170 may be a register or a storage area within flash memory 130 for temporarily storing information. Prefetch control 180 may control prefetching of information stored in memory cell array 150. The prefetch information may be transferred to buffer 170 and/or cache memory 120. In this embodiment, prefetch control 180 is internal to flash memory 130. In alternate embodiments, prefetch control 180 may be external to flash memory 130. For example, prefetch control 180 may be integrated with processor 110 or portions of the functionality of prefetch control 180 may be implemented in processor 110 as, for example, a software application, module, or routine. In other embodiments, prefetch control 180 may be external to flash memory 130 and physically closer or architecturally closer to flash memory 130 than processor 110. In addition, in this embodiment, buffer 170 is illustrated as internal to flash memory 130. In alternate embodiments, buffer 170 may be may be external to flash memory 130 and may be physically closer or architecturally closer to flash memory 130 than processor 110. Alternatively, buffer 170 may be may be external to flash memory 130 and may be physically closer or architecturally closer to processor 110 than flash memory 130.

During a read operation, a software process executing in processor 110 may request information that is stored in flash memory 130. This requested information may be transferred from a storage location in memory cell array 150 to processor 110 for processing. The storage locations in memory cell array 150 may have corresponding addresses for accessing information in memory cell array 150. The requested information may also be transferred to cache memory 120. Therefore, in subsequent read operations, the requested information may first be found in cache memory 120.

In order to request information during a read operation, an address identifying the location of the requested information in memory cell array 150 may be transmitted to flash memory 130 from processor 110, and the requested information at the requested address in memory cell array 150 may be retrieved. The requested information may be transferred to buffer 170. As an example, although the scope of the claimed subject matter is not limited in this respect, the requested information may be 256 bits in size, and the operation of transferring 256 bits of information from memory cell array 150 to buffer 170 may take approximately three clock cycles. In this example, bus 140 may be a 64-bit bus, and therefore, transferring 256 bits of information from buffer 170 to either cache memory 120 or processor 110 may take approximately four clock cycles. Accordingly, in this example, transferring information from memory cell array 150 to either cache memory 120 or processor 110 may take approximately seven clock cycles, although the scope of the claimed subject matter is not limited in this respect.

A prefetch operation or prefetching may include retrieving information from memory cell array 150 prior to a request for the information by a software process executing in processor 110. The prefetching may be a speculative operation and the nonrequested information may never be requested. The nonrequested information may be transferred to buffer 170 and/or cache memory 120. The nonrequested information identified by the prefetch operation may be referred to as prefetch information.

Prefetching of information may improve system performance. For example, in the embodiment illustrated above of transferring 256 bits of information, during or after a read operation of the 256 bits of requested information, nonrequested information may be prefetched and placed in buffer 170. If the prefetch information is requested during a subsequent memory access and if this information is available in buffer 170 rather than in memory cell array 150, then the prefetch information may be transferred to either processor 110 or cache memory 120 in a total of four clock cycles rather than seven clock cycles. In this example, the amount of time to access the information from flash memory 130 is reduced, thereby increasing overall processing speed of computing system 100.

In order to identify or determine which information to prefetch, many prefetching algorithms may be used. For example, nonrequested information may be identified based on location of requested information in flash memory 130. In this example, nonrequested information located nearby or in close proximity to (e.g., adjacent or continuous to) the requested information may be prefetched.

In other embodiments, the nonrequested information may be identified based on the characteristics or attributes of the requested information. As an example, processor 110 or prefetch control 180 may be adapted to examine the requested information and determine if, for example, the requested information comprises a jump instruction and a jump address. If the requested information is a jump instruction, then the nonrequested information at the jump address may be prefetched from memory cell array 150 to buffer 170. As another example, if the requested information is an instruction that includes a conditional branch, then the data from the branch address may be prefetched. In another example, if the requested information is a branch or jump instruction that does not include an absolute address, then prefetch control 180 may manipulate the address (e.g., add an offset or mask some bits) to determine the absolute address of the nonrequested data. Since jump instructions may be different for different types of processors, prefetch control 180 may be adapted to interpret jump instructions of different families of processors.

In some embodiments, prefetching information from memory cell array 150 may be enabled or disabled. For example, processor 110 may transmit a prefetch enable signal to prefetch control 180 to enable prefetching in flash memory 130. In this example, prefetch control 180 is responsive to the prefetch enable signal that may be asserted by processor 110 to enable prefetching in flash memory 130. Disabling the prefetching resources in computing system 100 may reduce power consumption of computing system 100.

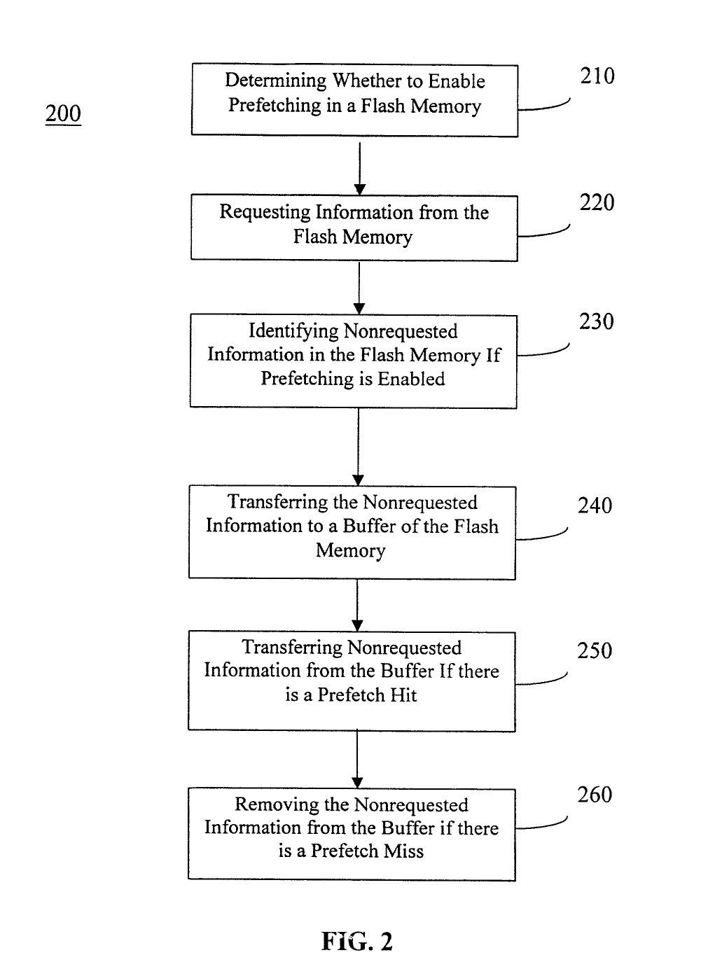

Turning to FIG. 2, a method 200 to retrieve information in accordance with an embodiment of the claimed subject matter is described. This method may be illustrated with reference to computing system 100 (FIG. 1). In some embodiments, prefetch control 180 and/or processor 110 may include circuitry, software, or a combination of circuitry and software to implement the method described in FIG. 2. Although the individual actions of method 200 are illustrated and described as separate actions, one or more of the individual actions may be performed concurrently and the scope of the claimed subject matter is not limited to performing these operations in the order illustrated.

This embodiment may begin with determining whether to enable prefetching of information from memory cell array 150 in flash memory 130 (block 210). This determination may be made based on predetermined knowledge of the memory accesses. For example, a system designer or software programmer may know that a group of memory accesses is related, e.g., a system designer may know that blocks of data are stored sequentially in memory cell array 150. Therefore, in this example, a system designer may choose to enable prefetching of nonrequested information that is located in close proximity to the requested information.

The method illustrated in FIG. 2 may include a read operation performed by a software process executing in processor 110. This read operation may include requesting information from flash memory 130 (block 220) by transmitting a request address to flash memory 130, wherein the request address corresponds to the storage location of the requested information in memory cell array 150. The read operation may further include transferring the requested information to buffer 170 followed by transferring the requested information from buffer 170 to processor 110 and/or to cache memory 120.

Prefetching may comprise identifying nonrequested information in memory cell array 150 if prefetching is enabled (block 230). In some embodiments, identifying nonrequested information may comprise identifying nonrequested information located in a region of memory cell array 150 based on the location of the requested information. For example, prefetching may comprise identifying nonrequested information located adjacent to the requested information. In alternate embodiments, identifying nonrequested information may comprise identifying nonrequested information located in a region of memory cell array 150 based on the characteristic of the requested information. During or after identifying of the prefetch information, the address of the prefetch information in memory cell array 150 may be stored and may be referred to as the prefetch address.

The nonrequested information may be transferred to buffer 170 from memory cell array 150 (240). The prefetch operation may be followed by a subsequent read operation that may include transmitting a request address to flash memory 130. Prefetch control 180 may compare the request address to the prefetch address. During a request to retrieve information from flash memory (e.g., during a read operation), if the requested address and the prefetch address match (e.g., is equal to or approximately equal to), this may be referred to as a “prefetch hit.” Conversely, if the requested address and the prefetch address do not match, this may be referred to as a “prefetch miss.”

If the request address matches the prefetch address, then prefetch control 180 may enable transferring of the previously nonrequested or prefetch information from buffer 170 to processor 110 (block 250). In some embodiments, the prefetch information may also be transmitted to cache memory 120. If the request address does not match the prefetch address, then prefetch control 180 may prevent transferring of the nonrequested information from buffer 170 to processor 110. The nonrequested information may be removed from buffer 170 if there is a prefetch miss (block 260).

Efficiency of computing system 100 may be improved by only transferring prefetch information from buffer 170 if there is a prefetch hit. For example, the energy and resources used to transfer prefetch information from buffer 170 to either processor 110 or cache memory 120 may be conserved. Therefore, by only transferring prefetch information from buffer 170 if there is a prefetch hit, the power consumption of computing system 100 may be reduced and bus 140 may be free to handle other transfers of information.

While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

1. A method, comprising:
enabling prefetching in a flash memory; and
identifying nonrequested information in the flash memory if prefetching is enabled.

2. The method of claim 1, wherein enabling prefetching in a flash memory comprises transmitting a prefetch signal to the flash memory.

3. The method of claim 1, further comprising:
transferring requested information from the flash memory, wherein the requested information is located in a first region of the flash memory; and
wherein identifying further comprises identifying nonrequested information in a second region of the flash memory based on the location of the requested information.

4. The method of claim 3, wherein identifying further comprises identifying nonrequested information located adjacent to the first region of the flash memory and wherein the second region is adjacent to the first region.

5. The method of claim 1, further comprising:
transferring requested information from the flash memory; and
wherein identifying further comprises identifying nonrequested information located in the flash memory based on a characteristic of the requested information.

6. The method of claim 5, further comprising:
determining if the requested information comprises a jump instruction and a jump address; and
wherein identifying nonrequested information further comprises identifying nonrequested information based on the jump address.

7. The method of claim 1, wherein prefetching comprises transferring the nonrequested information to a buffer in the flash memory.

8. The method of claim 1, wherein prefetching comprises transferring the nonrequested information from the flash memory to a storage device having an access time less than an access time of the flash memory.

9. The method of claim 8, wherein the prefetching further comprises:
generating a prefetch address based on the location of the nonrequested information in the flash memory;
receiving a request address;
comparing the request address to the prefetch address; and
wherein transferring comprises transferring the nonrequested information from the flash memory to a storage device having an access time less than an access time of the flash memory if the prefetch address is equal to the request address.

10. An article comprising a storage medium having stored thereon instructions, that, when executed by a computing platform, result in:
enabling prefetching in a flash memory; and
identifying nonrequested information in the flash memory if prefetching is enabled.

11. The article of claim 10, wherein the instructions, when executed, further result in:
transferring requested information from the flash memory, wherein the requested information is located in a first region of the flash memory; and
wherein identifying further comprises identifying nonrequested information in a second region of the flash memory based on the location of the requested information.

12. A nonvolatile storage device including a floating gate to store a charge, comprising:
a prefetch control responsive to a prefetch enable signal and adapted to prefetch nonrequested information from the nonvolatile storage device if the prefetch enable signal is asserted.

13. The nonvolatile storage device of claim 12, further comprising a buffer to store the nonrequested information, wherein the nonrequested information is transferred from a location in the nonvolatile storage device to the buffer during or after asserting of the prefetch signal.

14. A system, comprising:
a processor adapted to assert a prefetch enable signal; and
a flash memory external to the processor and coupled for receiving the prefetch enable signal, wherein the flash memory comprises a prefetch control adapted to prefetch nonrequested information in the flash memory if the prefetch enable signal is asserted; and
a volatile memory coupled to the flash memory.

15. The system of claim 14, wherein the flash memory further comprises a buffer to store the nonrequested information, wherein the nonrequested information is transferred from a location in the nonvolatile storage device to the buffer during or after asserting of the prefetch signal.

16. The system claim 14, wherein the prefetch control is adapted to compare a request address from the processor to the address of the nonrequested information in flash memory.

17. The system of claim 16, wherein the prefetch control enables transfer of the nonrequested information from the flash memory to the processor if the request address is equal to the address of the nonrequested information.
